(19) United States
(12) Patent Application Publication
(10) Pub. No.: US 2014/0232832 A1
(43) Pub. Date: Aug. 21, 2014

(54) Surgical illumination device

(71) Applicant: Leica Microsystems (Schweiz) AG, Heerbrugg (CH)

(72) Inventor: Ulrich Sander, Rebstein (CH)

(21) Appl. No.: 14/180,176

(22) Filed: Feb. 13, 2014

(30) Foreign Application Priority Data
Feb. 18, 2013 (DE) 10 2013 202 575.0

(51) Int. Cl. H04N 13/02

(52) U.S. Cl. CPC H04N 13/0242; H04N 13/0253
USPC 348/48

(57) ABSTRACT

A surgical illumination device (1) having illuminating means (2) distributed over an area (A) and a stereoscopic image acquisition device (10) having two optical channels (10a, 10b) which each generate a monoscopic image of an illuminated object (6). At least three optical channels can be present, each of which may be arranged with its object-side channel end (D1, D2, D3; C1, C2, C3, C4, C5; OL, OR, UL, UR) inside the area (A) at its periphery. Two object-side channel ends can be arranged at a same distance to at least one other channel end. If one (D2, C3, UR) of the optical channels related to the two object-side channel ends (D2, D3; C3, C4; OL, UR) is no longer supplying a monoscopic image, the other one (D3, C4; OL) of the optical channels related to said two object-side channel ends can generate a stereoscopic image.

### CROSS REFERENCE TO RELATED APPLICATIONS

This application claims priority of German patent application number 110 2013 202 575.0 filed Feb. 18, 2013, the entire disclosure of which is incorporated by reference herein.

### FIELD OF THE DISCLOSURE

The present disclosure relates to a surgical illumination device having illuminating means distributed over an area, and having a stereoscopic image acquisition device having two optical channels each of which is embodied to generate a monoscopic image of an object illuminated by the illumination device, and which are respectively arranged with their object-side channel end inside the area, and to a stereoscopic image acquisition method.

### BACKGROUND OF THE DISCLOSURE

In modern operating theaters, surgical illumination devices not only have the task of optimally illuminating that region of a patient upon which surgery is to be performed. Modern surgical illumination devices often also comprise, in addition to illuminating means, cameras in order to document the operation. These cameras can be embodied as stereoscopic image acquisition devices that acquire a stereoscopic image of the operation.

The stereoscopic acquired image can, for example, be send to a 3D-capable screen, and assistants or students can track the operation and the individual movements or manual actions of the surgeon at very close range. This principle is well received not only in surgery but also, for example, in dentistry or pathology.

Conventional stereoscopic image acquisition devices that are arranged in space-saving fashion at the center of the illumination device are usually used for such illumination devices. The stereoscopic image acquisition devices comprise two optical channels whose object-side channel ends are arranged close to one another.

This results on the one hand in the problem that because of the proximity of the object-side channel ends to one another, the stereo base is very small. The stereo angle is thus also very small, and only a small stereoscopic effect, i.e. a small impression of spatial depth, is produced in the stereoscopic acquired image.

On the other hand, the problem exists that a surgeon or an assistant can get between the stereoscopic imaging device and that region of the patient upon which surgery is to be performed. The region upon which surgery is to be performed is then covered, and can no longer be imaged by the stereoscopic image acquisition device.

It is therefore desirable to make available a method and a device for stereoscopic imaging of an object that overcome the disadvantages recited above.

### SUMMARY OF THE DISCLOSURE

According to the present disclosure, a surgical illumination device as well as a stereoscopic image acquisition method having the features described herein are proposed. Further advantages and embodiments of the disclosure are evident from the description and the appended drawings.

A surgical illumination device according to the present invention possesses an area within which illuminating means are distributed. The surgical illumination device furthermore comprises a stereoscopic image acquisition device having two optical channels, each of which is embodied to generate a monoscopic image of an object illuminated by the illumination device. The optical channels are each arranged with their object-side channel end inside the area. At least three optical channels are present, each of which is arranged with its object-side channel end at the periphery of the area and inside the area. Two object-side channel ends are arranged at the same distance (stereo base) in relation to at least one channel end. The surgical illumination device further comprises an image monitoring unit, which is embodied in such a way that if one of the optical channels related to the two-object channel ends is no longer supplying a monoscopic image, the other one of the optical channels related to the two other object-side channel ends is used to generate a stereoscopic image.

The subject matter of the disclosure is furthermore a stereoscopic image acquisition method with at least three optical channels. The stereoscopic image acquisition method is suitable in particular for use of a surgical illumination device according to the present disclosure.

Be it noted at this juncture that the terms “monoscopic image” and “stereoscopic image” are intended to encompass both monoscopic individual images and stereoscopic individual images, as well as individual images grouped together respectively into monoscopic videos and stereoscopic videos.

### BRIEF DESCRIPTION OF THE DRAWINGS

The disclosure is schematically depicted in the drawings on the basis of an exemplifying embodiment, and will be explained in detail below with reference to the drawings, in which:

FIG. 1 schematically shows a surgical illumination device having a stereoscopic image acquisition device, according to the existing art.

FIG. 2 schematically shows a preferred embodiment of a surgical illumination device according to the present disclosure.

FIG. 3 is a schematic cross section of a preferred embodiment of a surgical illumination device according to the present disclosure.

FIGS. 4a-4d schematically show four preferred embodiments of a surgical illumination device according to the present disclosure.

Elements corresponding to one another are labeled with identical reference characters. For the sake of clarity, they are not explained repeatedly.

### DETAILED DESCRIPTION OF THE DISCLOSURE

The border of the area encloses the illuminating means with the smallest possible circumference; the area represents in particular the actual extent of the illumination device that faces toward an object to be illuminated. The area can in particular be embodied in circular fashion, although other shapes are also conceivable, in particular square, rectangular, elliptical, or star-shaped. A plurality of illuminating means, for example LEDs or halogen lamps, can be mounted within this area.

The area can be configured with a reflective coating or with various reflector constructions. The light of the illuminating means can thus be further intensified. In addition, a maximally homogeneous areal light source can be generated by the combination of illuminating means and reflective surface.

The area need not necessarily have a flat two-dimensional extent. The area can also, for example, be convexly or concavely curved. A convex curvature is particularly appropriate for further intensifying the light of the illuminating means and further increasing the homogeneity of the areal light source.

The object-side channel ends of the stereoscopic image acquisition device are furthermore arranged within the area. For example, one respective objective or one lens can be arranged as an object-side channel end within the area. The optical channels can comprise on the image side, behind the area as viewed from the object, systems made up of lenses, mirrors, and other optical elements, as well as image acquisition chips.

Micro-mirror actuators (digital micromirror devices, DMDs), micromirror arrays (MMAs), microelectromechanical systems (MEMs), electroactive polymers (EAPs), spatial light modulators (SLMs) can be used, for example, as optical elements in the optical channels.

It is particularly appropriate to configure all the optical channels identically, each having the same optical elements that each have identical mutual spacings and orientations. The optical elements of the optical channels can be integrated into the illumination device. For example, all the optical elements, as well as e.g. cable connections for the illuminating means, can be arranged inside a housing of the illumination device.

Of the optical channels that are present, two are selected and their monoscopic images are assembled to yield a stereoscopic image of the object. According to the present disclosure, the object-side channel ends of the optical channels are arranged at the periphery of the area, i.e. close to the edge of the illumination device. The greatest possible stereoscopic effect of the stereoscopic image of the object can thus be achieved.

It is also possible to prevent all the optical channels from being covered at the same time, so that no further monoscopic images of the object are acquired. For example, a user of the illumination device may get between the object and one of the optical channels. The closer to one another the object-side channels ends of the optical channels are located, the greater the risk that all the optical channels will be covered and that an image of the object can no longer be acquired. If at least one of the object-side channel ends is located at the periphery of the area, the risk that all the optical channels will be covered simultaneously is very much less.

Advantageously, in the surgical illumination device according to the present invention two object-side channel ends are arranged at the same distance (stereo base) to each of the respective other channel ends.

The surgical illumination device preferably comprises exactly four optical channels, all four of which are arranged with their object-side channel end at the periphery of the area (A). It is particularly appropriate for the mutual spacings of the object-side channel ends to be selected to be as large as possible. For this purpose, the four object-side channel ends can in particular constitute the vertices of a square or of a rectangle, the respective center point of the square or of the rectangle coinciding with the center point or centroid of the area.

In this embodiment, it is possible to ensure not only that at least one monoscopic image of the object under the same stereo base is acquired at all times, but also that a stereoscopic image of the object is acquired at all times, provided not all optical channels of the illumination device are occluded. Even if one of the optical channels is covered, three other optical channels are still present, two of which can be used for a stereoscopic image of the object.

The image monitoring unit selects two of the optical channels and assembles the monoscopic images of those two optical channels to yield a stereoscopic image of the object. If one of the two selected optical channels is then no longer supplying an image of the object, for example because a user is located between the object and the optical channel or because a technical defect exists in the optical channel, the image monitoring unit selects two of the other optical channels. The image monitoring unit can select two new optical channels, or the image monitoring unit selects only one new optical channel and continues to use the optical channel that was previously selected and is still supplying an image of the object.

In order to detect whether one of the selected optical channels is no longer supplying an image of the object, in particular a computer program or an algorithm can executed in the image monitoring unit. For example, the monoscopic image of each optical channel can be monitored. If the brightness and/or intensity and/or contrast of the monoscopic image changes by a predetermined factor, this is an indication that the optical channel is no longer imaging the object.

Alternatively or additionally, the images of the two selected optical channels can also be compared with one another. If the images deviate greatly from one another, the image monitoring unit selects two different optical channels. The image monitoring unit can also continuously monitor all the optical channels, The image monitoring unit can then always selects two (optionally, new) optical channels whose images do not deviate greatly from one another. It is thereby possible to prevent selection of a new optical channel that is also covered.

It is also conceivable for an additional monoscopic or stereoscopic external image acquisition device to be present outside the planar illumination device. This external image acquisition device can, for example, image the object illuminated by the illumination device and serve as a reference image for the images of the optical channels of the stereoscopic image acquisition device. If a monoscopic image of one optical channel deviates from the reference image, that optical channel can be excluded from image generation.

Preferably each of the optical channels comprises an afocal lens system and an autofocus device, the autofocus device applying control to the afocal lens system. The beam path of the lens systems can be embodied respectively as a Galilean beam path. In particular, a finite beam path coming from the object is first imaged by a lens or a lens system into an infinite beam path. Lastly the infinite beam path is imaged, by further lenses or a further lens system, back into a finite beam path. In particular, the autofocus device applies control to the lens systems of all optical channels together. This ensures that the optical properties of all the optical channels are the same, in order to obtain a useful stereoscopic image.

Advantageously, because of the large stereo base, each of the optical channels comprises a separately controllable magnification system. The magnification systems can be embodied, for example, as a zoom objective, an objective changer, or a magnification changer. The magnification system is embodied in particular as an afocal lens system having a Galilean beam path. The magnification systems of the individual optical channels are accordingly embodied to be controllable together, so that an identical magnification for each of the optical channels is guaranteed.

Preferably each of the optical channels comprises an image acquisition chip. The image acquisition chip can be embodied, for example, as a CCD chip or a CMOS sensor. The images acquired by the respective image acquisition chips are assembled, in particular by the image monitoring unit, to yield the stereoscopic image.

Alternatively, for example, only two image acquisition chips can also be present. One of the image acquisition chips is provided for imaging a left image, the other image acquisition chip is provided for imaging a right image of the stereoscopic image.

Alternatively, the stereoscopic image acquisition device comprises, for all optical channels, one common image acquisition chip that comprises different regions for the left and the right image.

In an alternative embodiment, each optical channel comprises a segment or a fraction of a main objective. The fractions of the main objective of all the optical channels can be assembled to yield the main objective. The main objective is separated, for example along a section surface that contains the optical axis, into parts each identically dimensioned and having an identical shape and size. Each of these parts forms one fraction of the main objective. The stereoscopic image acquisition device can thus be implemented in telescope fashion, with two parallel optical channels possessing one common main objective.

The stereoscopic image acquisition device stereoscopically images, in particular, a patient or a portion of the patient upon which an operation is to be carried out. The stereoscopic image can, for example, be sent directly to the surgeon by means of a head-mounted instrument. The stereoscopic image can also, for example, be sent to a stereoscopic screen, for example a 3D-capable television unit, so that assistants or medical students can also follow the operation.

The disclosure further relates to a stereoscopic image acquisition method with at least three optical channels, which is suitable in particular for a surgical illumination device according to the present disclosure discussed in detail above. All statements in connection with the surigcal illumination device and its embodiments apply in the same fashion to the method according to the present disclosure without requiring separate explanations for that purpose. The description below of the method and of its embodiments will therefore be limited to the method steps required therefor.

The object-side channel ends of the optical channels can be arranged in particular within an area of a surgical illumination device, and in that context distributed arbitrarily within the area. If the area is configured, for example, in a circular shape, the object-side channel ends can be located on a circle that is concentric with the area and has a suitable radius.

Each of the at least three optical channels acquires a monoscopic image of an object. In a first method step, a first optical channel and a second optical channel are selected, and the monoscopic images of the first and of the second optical channel are assembled to yield a stereoscopic image of the object.

If one of the two selected channels is no longer acquiring a monoscopic image of the object, for example because the optical channel is covered by a user or because it has a technical defect, in a second method step a third optical channel is selected. The monoscopic images of the third optical channel and of a further optical channel, which are respectively acquiring a monoscopic image of the object, are assembled to yield a stereoscopic image of the object under the same stereo base. The further optical channel that is (still) supplying an image can be either the first or the second aforementioned channel or, in the case of four or more optical channels, can be a further different channel. Selection of the respective optical channels can be accomplished in accordance with predefined criteria.

Advantageously, the first and the second optical channel are selected in such a way that object-side channel ends of the first and of the second optical channels have the largest possible spacing from one another. Depending on the application, the greatest possible stereoscopic effect of the image of the object can be desired. For this it is appropriate for the object-side channel ends of the first and of the second optical channel to have the largest possible spacing from one another.

Alternatively, it can also be desired for the spacing of the object-side channel ends to be in a predetermined range. In particular, a specific reference spacing can be predefined. This reference spacing can be selected, for example, in such a way that the resulting spatial depth of the stereoscopic image corresponds to the spatial visual perception of the human eye. In this case the first and the second optical channel are selected in such a way that the spacing of the object-side channel ends of the first and of the second optical channel are located as close as possible to the reference spacing.

The third optical channel is preferably selected in such a way that the object-side channel end of the third optical channel has the largest possible spacing from the object-side channel end of the optical channel that is likewise acquiring a monoscopic image of the object. The greatest possible stereoscopic effect of the stereoscopic image can thus continue to be guaranteed.

In an alternative embodiment, the third optical channel can also be selected in such a way that the object-side channel end of the third optical channel has the largest possible spacing from the object-side channel end of the optical channel that is no longer supplying a monoscopic image of the object. It is thereby possible to ensure that the third optical channel is not also covered, and that a channel that is likewise not supplying a monoscopic image of the object is selected.

Alternatively, the third optical channel is selected in such a way that the object-side channel end of the third optical channel has the smallest possible spacing from the object-side channel end of the optical channel that is no longer acquiring a monoscopic image of the object. It is thereby possible to ensure that the third optical channel is, to the greatest extent possible, imaging the same region of the object as the optical channel that is no longer supplying a monoscopic image. The transition between the stereoscopic image of the first and second optical channel, and of the third and the other optical channel, is therefore made as unobtrusive as possible. A user hardly notices the transition. Unpleasant changes in visual impressions can thus be avoided. In order to prevent selection as a third channel of an optical channel whose object-side channel end is likewise occluded, all the optical channels can, for example, be monitored. A check is made in this context as to whether the optical channel having the smallest possible spacing is likewise covered. If that is the case, that optical channel which has the second-smallest possible spacing is checked. If that is likewise occluded, that optical channel which has the third-smallest possible spacing is checked, and so forth.

The best possible selection can be made according to predefined criteria, or else instantaneously, also successively, until the best possible image is obtained.

Preferably, if one of the first and second optical channels fail to deliver a monoscopic image, a third optical channel is selected in such a way that the third optical channel and the optical channel that is still supplying an image have the same stereo base as the first and the second optical channels. Alternatively, in such a case, a third and a fourth optical channel can be selected in such a way that the third and the fourth optical channels have the same stereo base as the first and the second optical channels.

Preferably the object-side channel ends of the optical channels are arranged in a star shape or on a circular path. Alternatively or additionally, an optical channel end can also be located at the center point of the circular path or at the centroid of the star shape.

It is understood that the features recited above and those yet to be explained below are usable not only in the respective combination indicated, but also in other combinations or in isolation, without departing from the scope of the present disclosure.

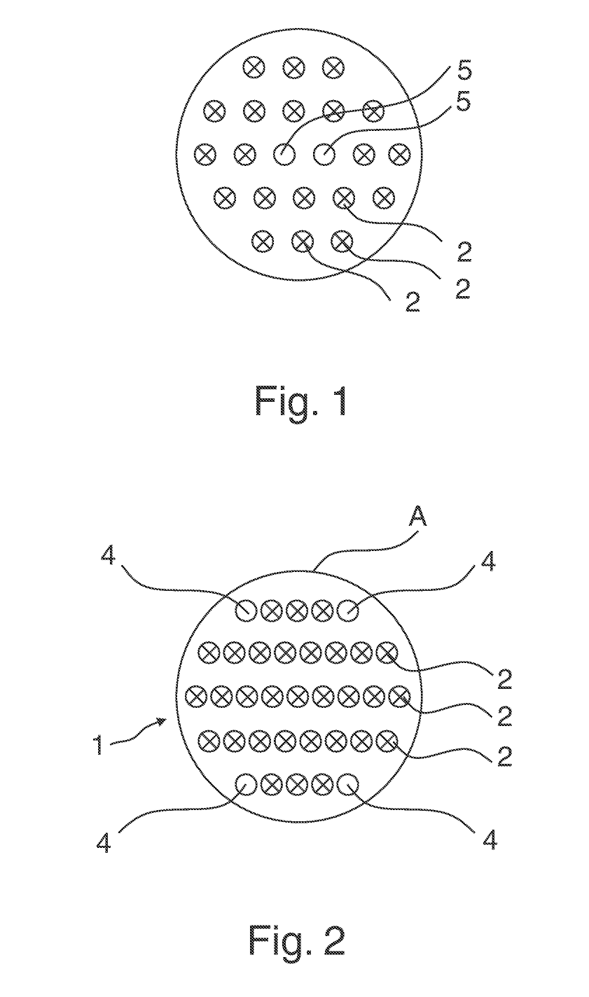

FIG. 1 schematically depicts a surgical illumination device having a stereoscopic image acquisition device, according to the existing art. The surgical illumination device comprises multiple LEDs 2. Arranged close to one another near the center point of the surgical illumination device are two objective lenses 5 that constitute the object-side channel ends of optical channels of the stereoscopic image acquisition device.

The spacing between the surgical illumination device and an object that is being imaged with the stereoscopic image acquisition device is variable. The stereo angle is accordingly variable. But because the stereo base, i.e. the spacing between two objective lenses 5, is small, the stereo angle and thus the stereoscopic effect of the stereoscopic image is small. The risk also exists that both optical channels may be occluded simultaneously, and that an image of the object can no longer be acquired.

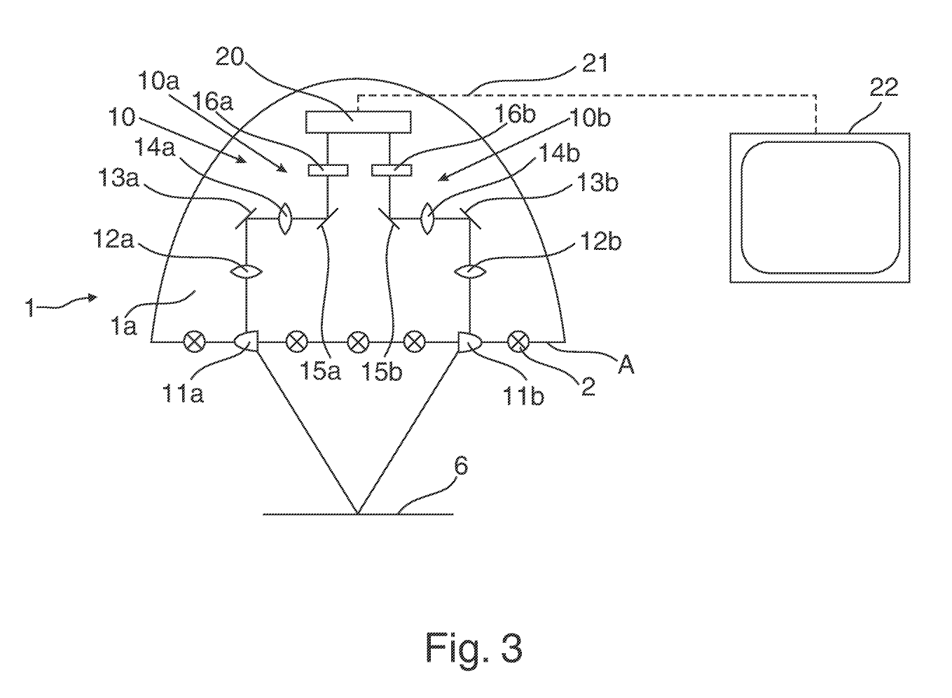

FIG. 2 schematically depicts a preferred embodiment of a surgical illumination device according to the present disclosure.

In this special embodiment, the surgical illumination device 1 has a round shape. The area of this round shape is labeled A. Multiple illuminating means, embodied as LEDs 2, are arranged inside the area. The individual LEDs radiate a while light at high intensity. Surgical illumination device 1 serves as an areal light source.

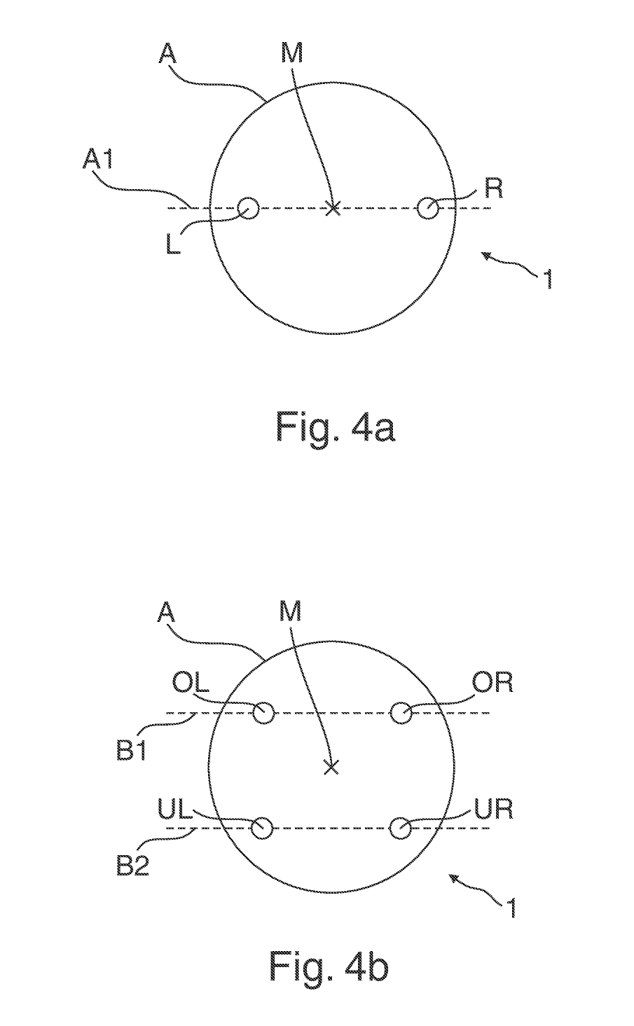

Objective lenses 4 are also arranged within area A at the periphery of area A. Objective lenses 4 constitute the object-side channel ends of optical channels of a stereoscopic image acquisition device. The optical channels extend behind area A and are explained in detail in the course of FIG. 3.

FIG. 3 is a lateral cross section depicting an embodiment, implemented as a surgical illumination device 1. Analogously to FIG. 2, surgical illumination device 1 has a round area A and illuminating means embodied as LEDs 2.

A housing 1a of surgical illumination device 1 is arranged on area A. Present within housing 1a are, inter alia, cable connections for the LEDs in order to supply the LEDs with power. For the sake of clarity, the cable connections are not depicted in FIG. 3.

In FIG. 3, two segments or fractions 11a and l lb of a main objective are arranged in area A of surgical illumination device 1. Segments 11a and 11b of the main objective represent the object-side channel ends of two optical channels 10a and 10b of a stereoscopic image acquisition device. A main objective, embodied as a lens, has been cut through at its center along an optical axis in order to obtain two segments 11a and 11b. The stereoscopic image acquisition device is thus implemented in telescope fashion. Instead of segments 11a and 11b, conventional objective lenses 4 in combination with prisms can also be used as object-side channel ends.

For the sake of clarity, only two optical channels are depicted in FIG. 3. The description that follows is not intended to be limited to two optical channels, however, but instead is intended to be valid analogously for any useful number of optical channels. In addition, optical channels 10a and 10b are depicted merely schematically for the sake of clarity, and can also comprise more lenses, prisms, and mirrors than are depicted in FIG. 3.

Optical channels 10a and 10b are part of a stereoscopic image acquisition device 10 and each image a monoscopic image of an object 6 onto an image acquisition chip embodied as a respective CCD chip 16a, 16b. Object 6 is assumed in this example to be a region of a patient upon which surgery is to be performed.

Optical channels 10a and 10b each comprise an afocal lens system. The afocal lens systems each comprise respective segments 11a, 11b of the main objective, a magnification system embodied as a respective zoom optic 12a, 12b, and a respective camera lens 14a, 14b. From object 6, a finite beam path strikes segments 11a, 11b. Segments 11a, 11b image this finite beam path into an infinite beam path. The infinite beam path passes through zoom optic 12a, 12b and is imaged by the respective camera lens 14a, 14b into a finite beam path that is ultimately imaged onto the respective CCD chip 16a, 16b.

Optical channels 10a and 10b furthermore each comprise two deflection mirrors 13a, 13b and 15a, 15b. CCD chips 16a and 16b are connected to an image monitoring unit 20.

Image monitoring unit 20 serves on the one hand as an autofocus device in order to control, together, both the focus and the magnification of optical channels 10a and 10b and of the further optical channels (not depicted here). Image monitoring unit 20 can control the position both of the respective zoom optics 12a, 12b and of the respective camera lenses 14a, 14b for each respective optical channel 10a, 10b.

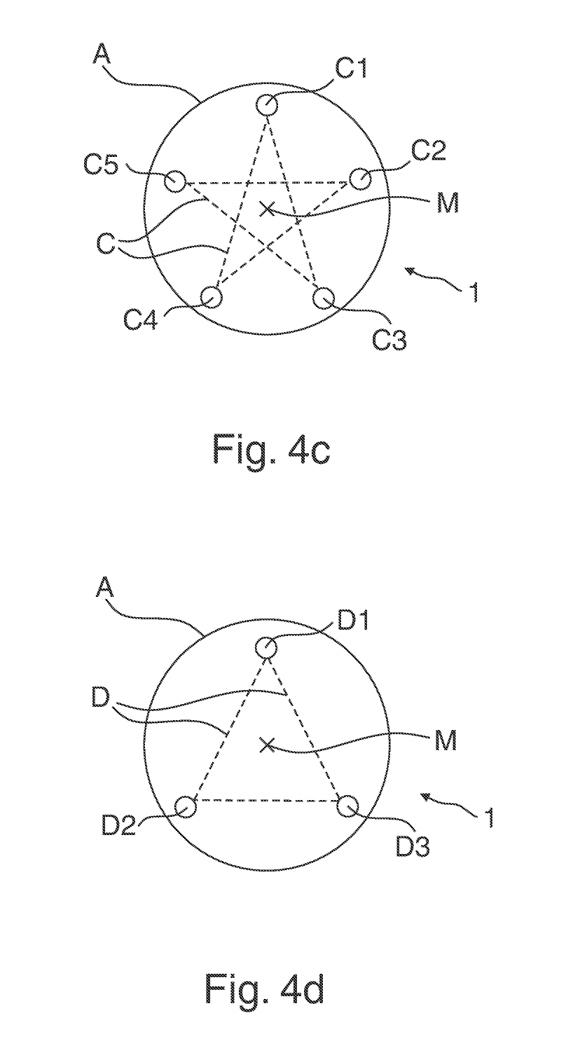

Image monitoring unit 20 is on the other hand set up to carry out a preferred embodiment of a stereoscopic image acquisition method according to the present disclosure that is explained in detail in the course of FIGS. 4a-4d.

Image monitoring unit 20 transmits the monoscopic images acquired by the two optical channels 10a and 10b to a screen 22. Transmission can occur, for example, via a cable connection 21. Transmission by means of a radio connection is also conceivable.

The two monoscopic images are outputted on screen 22, and a user can, with suitable means, perceive the monoscopic images as a stereoscopic image of object 6. For example, 3D glasses can be used for stereoscopic perception of stereoscopic images, or screen 22 can be embodied as an autostereoscopic display or as a holographic display.

FIGS. 4a-4d schematically depict preferred arrangements of object-side channel ends within area A of surgical illumination device 1 according to FIGS. 2 and 3. In the interest of clarity, the LEDs are not depicted in FIGS. 4a-4d.

In FIG. 4a, surgical illumination device 1 shows two exemplary optical channels. The associated object-side channels ends L and R are located on an (imaginary) axis A1 that extends through the center point M of area A. Both object-side channel ends L and R are arranged at the periphery of area A.

As a result of the spacing, i.e. the stereo base, of the object-side channel ends L and R, which is several times greater than in the existing art, a large stereoscopic effect can be achieved and a stereoscopic image of object 6 is imaged with high spatial resolution. It is also possible to preclude the possibility of both object-side channel ends L and R being simultaneously covered by a user.

It is thereby possible to ensure that at least one monoscopic image of object 6 is acquired at all times.

In FIG. 4b, a surgical illumination device 1 comprises four optical channels (see FIG. 2). The four associated object-side channel ends OL, OR, UL, and UR are located on a circular path concentric with center point M of area A. At the same time, the four object-side channel ends OL, OR, UL, and UR constitute the vertices of a square that is located within said circular path. The upper object-side channel ends OL and OR are located on an axis B1; the lower object-side channel ends UL and UR are located on an axis B2. The axes B1 and B2 extend parallel to one another. All four object-side channel ends OL, OR, UL, and UR are arranged at the periphery of area A.

A surgical illumination device 1 according to FIG. 4b is suitable for carrying out a preferred embodiment of a stereoscopic image acquisition method according to the present disclosure. The stereoscopic image acquisition method is carried out by an image monitoring unit 20. Image monitoring unit 20 firstly selects two of the four optical channels as a first optical channel and a second optical channel, for example the optical channels having the lower object-side channel ends UL and UR.

If one of the two optical channels is occluded by a user, for example the second optical channel associated with UR, image monitoring unit 20 selects one of the remaining optical channels as a third optical channel. The selection can occur, for example, in such a way that the object-side channel end of the third optical channel is located as far away as possible from optical channel end UR that is no longer imaging a monoscopic image of object 6. Image monitoring unit 20 accordingly selects optical channel OL as a third optical channel, and assembles the images of the first optical channel associated with UL, and of the third optical channel associated with OL, to yield a stereoscopic image of object 6 under the same stereo base.

Alternatively, the image monitoring unit 20 can select optical channels OL and OR as the two (new) optical channels, provided that the optical channels OL and OR are still imaging monoscopic images of the object 6. Since the stereo basis between OL and OR on the one hand, and UL and UR, on the other hand, are the same, the image monitoring unit 20 delivers a stereoscopic image of object 6 under the same stereo base.

In FIG. 4c, a surgical illumination device 1 comprises five optical channels. The five associated object-side channels ends C1, C2, C3, C4, and C5 are arranged in a star shape. The star shape is indicated by axes C. All five object-side channel ends C1, C2, C3, C4, and C5 are arranged at the periphery of area A.

Two (imaginary) axes proceed from each object-side channel end. Each object-side channel end is thus, with reference to the star shape, connected by axes to two other object-side channel ends.

The star shape can be used for selection of the optical channels of image monitoring unit 20. For example, initially a first and a second optical channel can be selected in such a way that the associated object-side channel ends are located on one of the axes C of the star shape, for example the optical channels associated with the object-side channel ends C1 and C3. This criterion can also be used analogously for selection of a third optical channel. For example, if the optical channel associated with C3 is no longer supplying a monoscopic image of object 6, the optical channel associated with C4 is selected as a third optical channel. The object-side channel ends of the third optical channel, and of the optical channel that is still supplying a monoscopic image of object 6, are likewise located on an axis C of the star shape, thus under the same stereo base.

In FIG. 4d, a surgical illumination device 1 comprises three optical channels. The three associated object-side channel ends DE D2, and D3 constitute the vertices of an equilateral triangle D. Initially, optical channels D1 and D2 are selected. If one of the two optical channels becomes occluded, for example DE the two remaining optical channels D2 and D3 are automatically used.

The disclosure is not to be limited to the specific embodiments disclosed, and modifications and other embodiments are intended to be included within the scope of the disclosure.

### PARTS LIST

1 Surgical illumination device

1a Housing of surgical illumination device

A Area of surgical illumination device

2 LED, illuminating means

3 Reflective layer

4 Objective lens

5 Objective lens

6 Object

10 Stereoscopic image acquisition device

10a, b Optical channel

11a, b Segment of a main objective

12a, b Zoom optic

13a, b Deflection mirror

14a, b Camera lens

15a, b Deflection mirror

16a, b CCD chip

20 Image monitoring unit

21 Cable connection

22 Screen

M Center point of area A

A1 Axis

L Object-side channel end

R Object-side channel end

B1 Axis

B2 Axis

OL Object-side channel end

OR Object-side channel end

UL Object-side channel end

UR Object-side channel end

C Axes of a star shape

C1 Object-side channel end

C2 Object-side channel end

C3 Object-side channel end

C4 Object-side channel end

C5 Object-side channel end

D Axes of a triangle

D1 Object-side channel end

D2 Object-side channel end

D3 Object-side channel end

1. A surgical illumination device (1), comprising:
illuminating means (2) distributed over an area (A);
a stereoscopic image acquisition device (10) having at least three optical channels (10a, 10b), each of the at least three optical channels configured to generate a monoscopic image of an object (6) illuminated by the illumination device (1), and each of the at least three optical channels (10a, 10b) having an object-side channel end (D1, D2, D3; C1, C2, C3, C4, C5; OL, OR, UL, UR) arranged inside the area (A) at its periphery, two object-side channel ends of the at least three optical channel ends being arranged at a same distance to at least one other channel end of the at least three optical channel ends; and
wherein the surgical illumination device comprises an image monitoring unit (20), said image monitoring unit (20) being configured such that if one (D2, C3, UR) of the optical channels related to said two object-side channel ends (D2, D3; C3, C4; OL, UR) is no longer supplying a monoscopic image, another (D3, C4; OL) of the optical channels related to said two object-side channel ends is used to generate a stereoscopic image.

2. The surgical illumination device (1) according to claim 1, wherein said two object-side channel ends are arranged at a same distance to each of said other channel ends (D1, D2, D3; C1, C2, C3, C4, C5; OL, OR, UL, UR).

3. The surgical illumination device (1) according to claim 1, wherein the stereoscopic image acquisition device (10) has four optical channels (OL, OR, UL, UR) arranged with their object-side channel ends (OL, OR, UL, UR) at the periphery of the area (A).

4. The surgical illumination device (1) according to claim 1, wherein each optical channel (10a, 10b) comprises an afocal lens system and an autofocus device (20), the autofocus device (20) configured to control the afocal lens system.

5. The surgical illumination device (1) according to claim 1, wherien each of the at least three optical channels (10a, 10b) comprises a separately controllable magnification system (12a, 12b).

6. The surgical illumination device (1) according to claim 1, wherein each of the at least three optical channels (10a, 10b) comprises an image acquisition chip (16a, 16b)

7. The surgical illumination device (1) according to claim 1, wherien the stereoscopic image acquisition device (10) comprises one common image acquisition chip for all optical channels.

8. The surgical illumination device (1) according to claim 1, wherein each of the at least three optical channels (10a, 10b) comprises a segment of a main objective (11a, 11b), all segments (11a, 11b) of the main objective of the individual optical channels (10a, 10b) being configured to be assembled to yield the main objective.

9. A stereoscopic image acquisition method, comprising:
providing a sterescopic image acquisition device having at least three optical channels (UL, UR, OL), each optical channel being configured to acquire a monoscopic image of an object (6);
selecting a first optical channel (UL) and a second optical channel (UR);
assembling monoscopic images from the first optical channel (UL) and a second optical channel (UR) to yield a stereoscopic image of the object (6);
if one optical channel (UR) of the two selected channels (UL, UR) is no longer acquiring a monoscopic image of the object (6):
selecting a third optical channel (OL) and a further optical channel (UL); and
assembling monoscopic images of the object (6) from the third optical channel (OL) and the further optical channel (UL) to yield a stereoscopic image of the object (6).

10. The stereoscopic image acquisition method according to claim 9, wherein the first optical channel (UL) and the second optical channel (UR) are selected such that object-side channel ends of the first optical channel and of the second optical channel are spaced furthest away from one another.

11. The stereoscopic image acquisition method according to claim 9, wherein the third optical channel (OL) is selected such that an object-side channel end of the third optical channel is spaced furthest away from an object-side channel end (UL) of the further optical channel that is acquiring a monoscopic image of the object.

12. The stereoscopic image acquisition method according to claim 9, wherein the third optical channel is selected such that an object-side channel end (OL) of the third optical channel is spaced furthest away from an object-side channel end (UR) of the optical channel that is no longer supplying a monoscopic image of the object.

13. The stereoscopic image acquisition method according to claim 9, wherein object-side channel ends (C1, C2, C3, C4, and C5) of the optical channels are arranged in a star pattern.

14. The stereoscopic image acquisition method according to claim 9, wherein object-side channel ends (OL, OR, UL, UR) of the optical channels are arranged in a circular pattern.
